(19) United States
(12) Patent Application Publication
(10) Pub. No.: US 2026/0140841 A1
(43) Pub. Date: May 21, 2026

(54) SYSTEMS AND METHODS FOR SOFTWARE FEATURE PERFORMANCE ASSESSMENT

(71) Applicant: ServiceNow, Inc., Santa Clara, CA (US)

(72) Inventor: Efrat Barkai, Givatayim (IL)

(21) Appl. No.: 18/954,669

(22) Filed: Nov. 21, 2024

(51) Int. Cl. G06F 11/30; G06N 3/04

(52) U.S. Cl. CPC G06F 11/302; G06N 3/04

(57) ABSTRACT

A method includes providing, to a trained neural network, a data set including a first plurality of data entries, where the data set is associated with a usage of a software feature, where the trained neural network is configured to identify relationships between a plurality of performance metrics respectively characterizing the first plurality of data entries, where the trained neural network includes a performance calculation model associated with the software feature. The performance calculation model is applied to the data set to generate a performance score. The performance score is transmitted to a device associated with the data set for display.

### TECHNICAL FIELD

The present disclosure relates generally to systems and methods for determining the impact that a software feature has on system or task performance as experienced by a user, specifically by synthesizing various performance metrics into a comprehensive indexed performance score.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A software platform is an environment that allows software to operate and interact with hardware and other software programs. Software platform providers release new or updated software features to improve the functionality and usability of the platform. Example features include new software products, various artificial intelligence (AI) components (e.g., recommendation engines, natural language processing models), new user interfaces (UIs), accessibility controls, and cross-functional capabilities. However, it is often difficult to determine how these new features impact the platform. With this in mind, improved systems and methods are needed to provide organizations a holistic assessment of the impact of features on the software platform.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes providing, to a trained neural network, a data set including a first plurality of data entries, where the data set is associated with a usage of a software feature, where the trained neural network is configured to identify relationships between a plurality of performance metrics respectively characterizing the first plurality of data entries, where the trained neural network includes a performance calculation model associated with the software feature. The performance calculation model is applied to the data set to generate a performance score. The performance score is transmitted to a device associated with the data set for display.

In another embodiment, a system includes a processor and a memory that is accessible by the processing circuity. The memory stores instructions that, when executed by the processing circuity, cause the processing circuity to execute a client instance, where the client instance is configured to perform operations. These operations include providing, to a trained neural network, a data set including a first plurality of data entries, where the data set is associated with a usage of a software feature, where the trained neural network is configured to identify relationships between a plurality of performance metrics respectively characterizing the first plurality of data entries, where the trained neural network includes a performance calculation model associated with the software feature. The operations also include applying the performance calculation model to the data set to generate a performance score, and transmitting the performance score to a device associated with the data set for display.

In a further embodiment, a non-transitory, computer readable medium includes instructions that, when executed by processing circuity, cause the processing circuitry to perform operations. These operations include providing, to a trained neural network, a data set including a first plurality of data entries, where the data set is associated with a usage of a software feature, where the trained neural network is configured to identify relationships between a plurality of performance metrics respectively characterizing the first plurality of data entries, where the trained neural network includes a performance calculation model associated with the software feature. The operations also include applying the performance calculation model to the data set to generate a performance score, and transmitting the performance score to a device associated with the data set for display.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server that supports and enables a client instance configured to manage a database and a performance calculation model, in accordance with aspects of the present disclosure;

FIG. 5 is a graph depicting performance scores for users of a software feature;

FIG. 6 is a flowchart depicting a process of aggregating various performance metrics into a performance score;

FIG. 7 is a graph depicting sample performance metrics for a software feature;

FIG. 8 is a graph providing an example embodiment of how a neural network can categorize different sources of performance data; and

FIG. 9 is a graph depicting how the disclosed system can generate suggestions for a user to improve its performance using a software feature.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

There are a variety of metrics that can be useful for determining whether a software feature benefits the businesses deploying the feature and the users that interact with it. Because software features often lead to significant changes in the way that users interact with a software platform, evaluating an isolated performance metric, or even a combination of performance metrics, fails to provide a comprehensive view of the software feature's impact on users. Recognizing this inability to obtain a holistic view of a software feature's impact on user performance and experience, many developers have relied solely on user feedback to determine the efficacy of a new or updated software feature. Even if a software developer has access to both statistics regarding performance metrics and anecdotal reviews by users, there is neither an efficient nor accurate way to combine these indicia to receive a comprehensive view of the software feature's impact. Indeed, a user experience engineer would have to sift through vast amounts of data and even then, may reach inaccurate results because of the innate difficulty in recognizing dependencies and connections between performance metrics in a computer program made up of many individual software features. This difficulty is exasperated by the non-linear relationship between identifiable performance metrics and software feature performance. It is now recognized that improved systems and methods for evaluating the performance of software features provide a needed benefit across the many industries that interact with software.

The present disclosure is directed to systems and methods for evaluating performance shifts in response to the release of software features. A computing system is configured to evaluate software feature performance by synthesizing multiple performance metrics into a performance score. The performance score may then be scaled according to a predefined performance index ranging from 0.00-1.00, 0-100, or other suitable ranges with the desired granularity (e.g., 0-10, 0-1,000, and so forth). The performance index range may be used to scale performance scores for each individual user, group of users, or enterprise (collectively referred to as “users”) using the software feature. The scaled performance score provides users with a holistic measure of how the software feature has impacted their performance. To calculate a user-specific performance score, the computing system, in one implementation, generates a performance calculation model through a two-phase process. The first phase of generating the performance calculation model is directed to obtaining usable data to train a neural network. In some embodiments, the computing system receives data entries from multiple users using a software feature. Each data entry may be associated with one or more performance metrics (e.g., mean time spent using the software feature). The computing system scales the data for use in machine learning algorithms and an autoencoder removes outliers from the training data.

After the training data is cleaned and identified, the second phase of generating the performance calculation model is training the neural network using the training data. Because relationships between performance metrics may be non-linear, the neural network is used to capture patterns in the training data, weigh performance metrics, and generate the performance calculation model. The performance calculation model represents a performance formula for all users, represented in the data entries, that use the software feature. Once the computing system generates the performance calculation model, it may use the model to calculate the performance scores for other users interacting with the software feature. Alternatively, the performance calculation model may be useful for one user to compare its own performance after implementing the software feature. After calculating the performance score, the computing system may scale the score according to the predefined performance index.

In some embodiments, the neural network may be configured to provide users with feedback for increasing productivity. For example, if a user seeks to increase its performance score by a set amount (e.g., 0.05), the computing system may use the neural network to identify and display instructions regarding one or more performance metrics that can be improved to reach the user's desired performance score. Further, in some embodiments, the neural network is configured to account for a user's propensity to adapt to updates to software features (the “adoption factor”). The adoption factor provides each user with a more accurate performance evaluation by using machine learning to determine the user's time to learn the software feature and scaling the user's performance score to account for decreases in productivity during learning periods. Accordingly, the disclosed systems and methods for evaluating performance shifts associated with software features provide a more holistic and tailored approach to doing so.

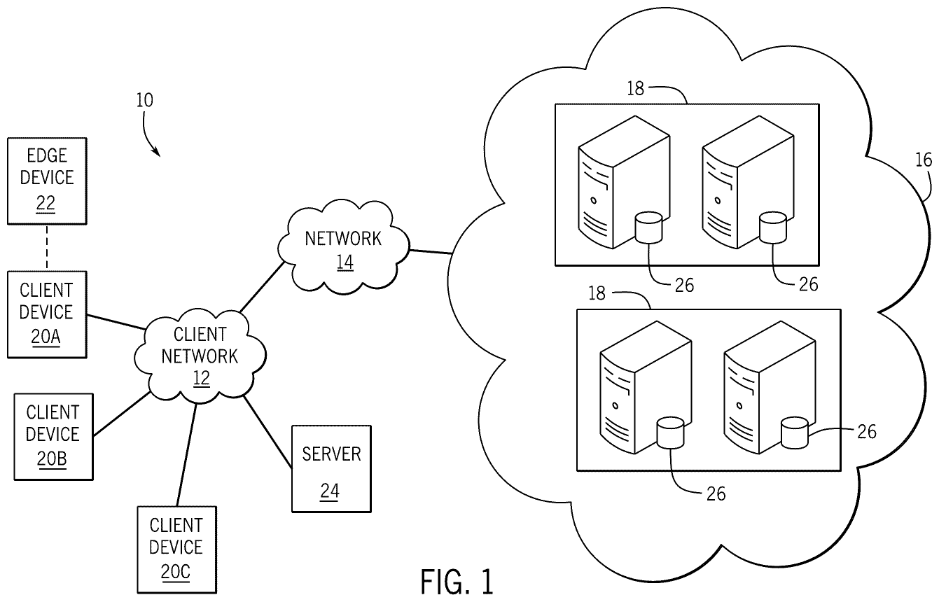

With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

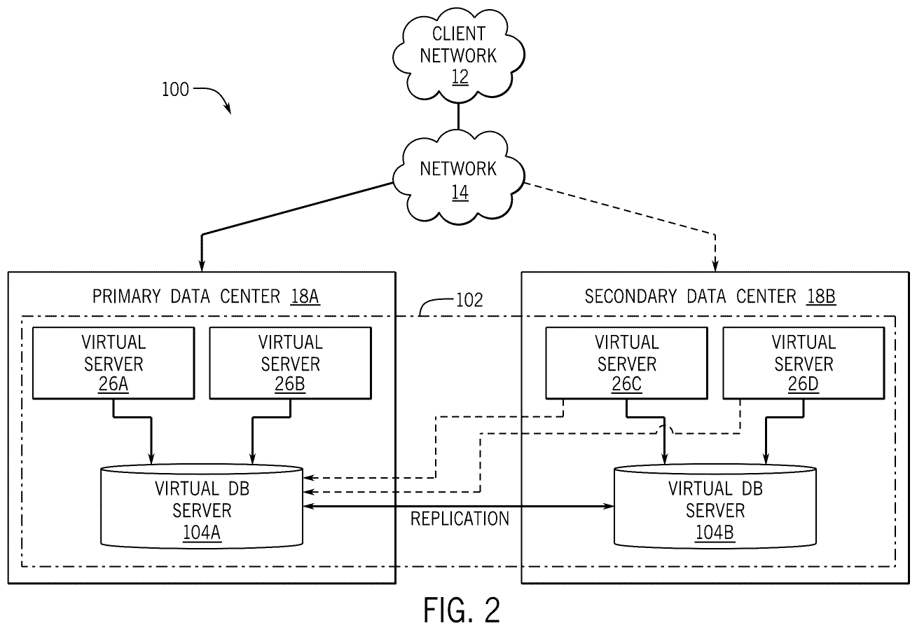

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

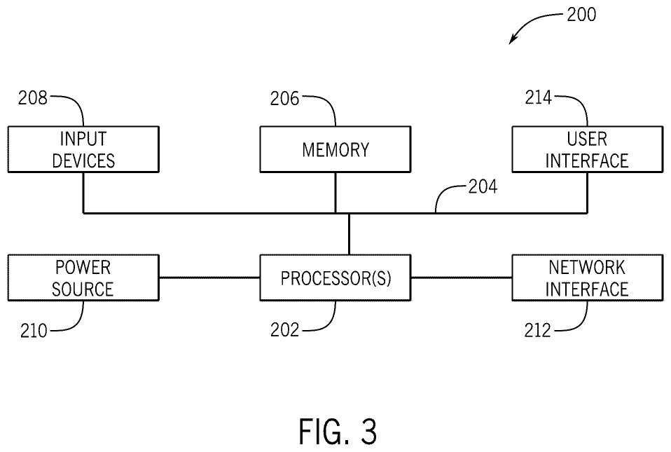

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202.

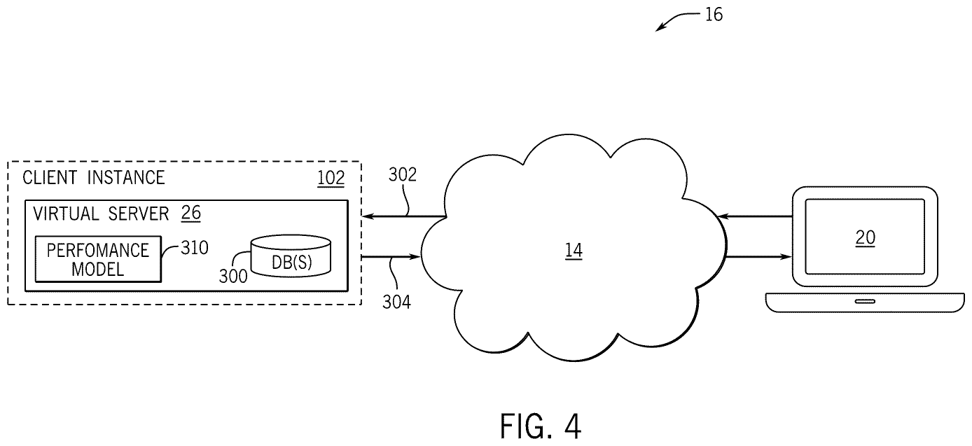

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser or a native application running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with the client instance 102 using an application and/or a web browser.

As shown in FIG. 4, virtual server 26 may host or otherwise have access to one or more databases 300, which may include one or more database tables for storing various types of data (e.g., employee data, customer data, vendor data, procurement data, accounting data, asset data, information technology (IT) data, product data, and so forth). The virtual server 26 may receive inputs 302 from the client device 20, which may include, for example, requests for the virtual server 26 to perform various operations on the databases 300. For example, the inputs 302 may include requests to retrieve one or more records from the database 300, modify records stored in the database 300, add records to the database, and so forth. The virtual server 26 may generate outputs 304 to be transmitted back to the client device. The outputs may include, for example, data from records retrieved from the database 300, confirmation that requested operations have been performed, and so forth. In some embodiments, the databases 300 are configured to store encrypted data. In such embodiments the virtual server 26 may use one or more performance models 310 to calculate performance scores corresponding to software feature data stored in the database 300.

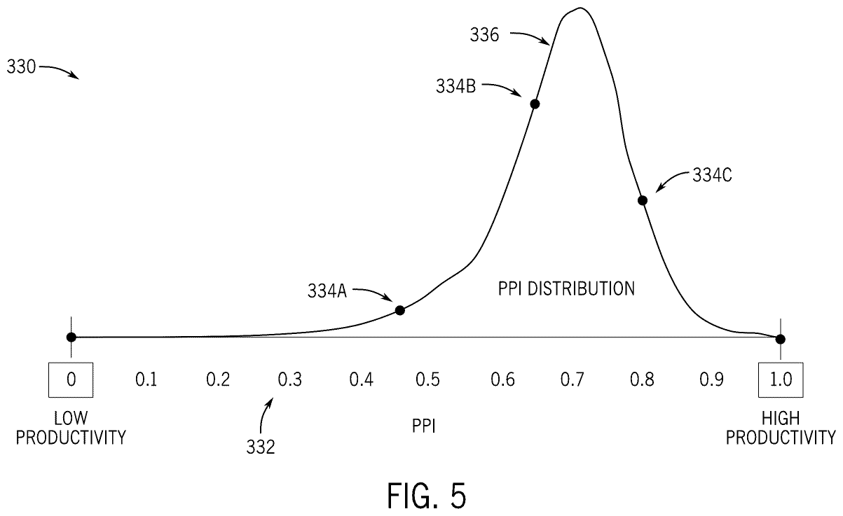

FIG. 5 provides a graph 330 representation of performance scores for a given software feature. This graph 330 is intended to serve as an introduction to performance scores. As described herein, a computing system uses a first data set to construct a performance model 310. The computing system can then use that performance model 310 to generate performance scores 332 for additional data sets. The first data set that the computing system uses to construct the performance model 310 may have many data entries (e.g., all users that interact with a software feature, all users that interact with a software feature within a specific industry). Then the computing system may run additional data sets through the performance model 310 to generate scaled performance scores 334A, 334B, 334C. The additional data sets may be more granular than the first data set used to construct the model. For example, a second data set may include performance metric data for individual users or teams of users. In other embodiments, the second data set may include performance metric data originating from the same source as the first data set (i.e., from one user). Taking the first and second data sets from a single source is useful, for example, for identifying internal performance shifts over time in response to software feature changes. The scaled performance scores 334A, 334B, 334C for these additional data sets are represented on the graph 330. In this example, performance scores 332 are modeled on a range from 0 to 1.0. A performance score 332 of 0 would represent the lowest possible performance for the software feature. Conversely, a performance score 332 of 1.0 represents the highest performance score for the software feature. A trend line 336 is also displayed on the graph 330. The trend line provides a broader picture of performance across all users for the software feature. In this way, users can compare their performance scores 334A, 334B, 334C to overall performance scores for all users using the software feature. Alternatively, the trend line 336 may allow a user to track its own performance shifts over a period of time.

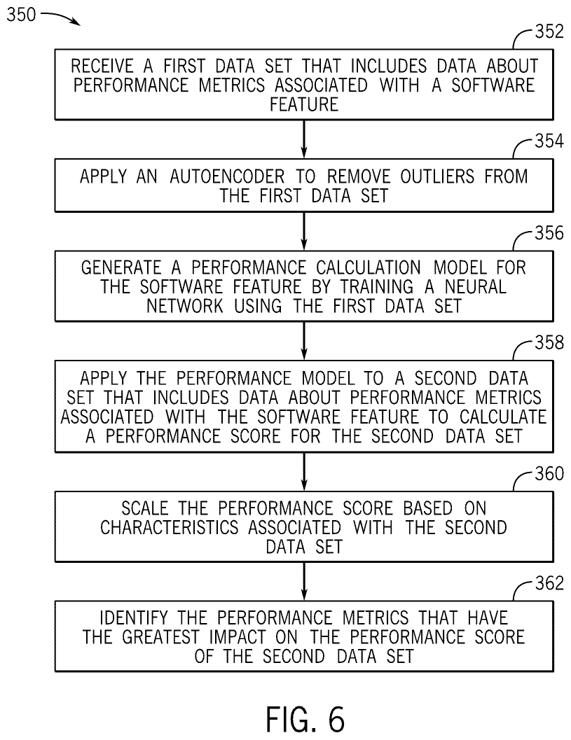

FIG. 6 depicts a flowchart 350 of one embodiment of the disclosed process. At block 352, a computing system receives a first data set of performance metric data for a software feature. The data may represent a wide variety of users. In some embodiments, the data set may refer to every user that interacts with the software feature. In other embodiments, the dataset may refer to a subset of users of the software feature (e.g., users within an enterprise, users with specific job roles). The computing system may receive the data set from local data or from external sources (e.g., a software platform transmitting performance data over the internet). The computing system may receive the performance data in real time, such as automatic collection as a user interacts with the software feature. As discussed herein, real time data collection provides advantages over existing techniques because it allows users to evaluate their performance with the software feature as performance metric data becomes available. In other embodiments, the computing system may receive a set of data periodically corresponding to use of the software feature for a specified amount of time (e.g., one day, one month).

As used herein, a “software feature” refers to any identifiable characteristic of a computer program. In some embodiments, the software feature may be interactive. For example, an artificial intelligence-based chat bot to assist users. In other embodiments, the software feature may be quasi-interactive. For example, a rearranged user interface that displays data sets in a central location. Alternatively, the software feature may not be interactive at all. For example, a software debugging feature to improve bottlenecks impacting application runtime. The software feature may be one isolated feature, as demonstrated in the previous examples, or it may be a combination of features (e.g., an updated software platform with all three of the above improvements). The software feature may be present in a web-based application, desktop application, mobile phone application, or a feature on any other device configurable to perform computing functions.

Performance metrics, as used herein, refer to a variety of factors indicative of how a software feature affects its users. As non-limiting examples, the performance metrics may be related to user interaction with the software feature. For example, the time users spend with the software feature, the user reversion to old software features, and user feedback or ratings of the software feature. Performance metrics may also be data related to the user effectiveness and productivity with the software. For example, if the software feature is intended to benefit IT support staff, a performance metric could be the mean time to resolve reported cases. As another non-limiting example, if the software feature is intended to benefit financial analysts, a performance metric could be generation or confirmation of net monthly returns. As demonstrated by the preceding examples, performance metrics are tailorable to the intended goals of the software feature. Further, the performance metrics may account for external information not directly salient to the software feature. Looking at the previous examples, if the IT staff face higher than average mean resolution times because of a complex and wide-ranging software bug, a performance metric may record problem complexity. Likewise, if the financial analyst's estimated net monthly returns drop because of a recession, a performance metric may record market changes. In both of these examples, decreases in performance are not indicative of the efficacy of the software feature. The computer system may use external performance metrics to account for unexpected or unavoidable shifts in performance. Thus, the performance metrics may be a variety of factors both directly and indirectly related to the software feature. The performance metrics may be standard for each software feature, or they may be specific to the function of the software feature. In this way, the performance metrics that ultimately become a part of the performance calculation model 310 are highly customizable to the many different software features that are designed for use in various fields.

Further, at block 352, the computing system normalizes the first data set. The computing system may scale numerical data values. For example, time ranges may be scaled to an integer value (e.g., 0 -60 minutes is 1, 60-120 minutes is 2). Similarly, categorical data may be encoded for use in a neural network. For example, positive reviews of a software feature can be represented as a 1 whereas negative reviews can be represented as a 0. In some embodiments, learned language models may assist the computing system performing categorical encoding. Both numerical scaling and categorical encoding help to ensure that the first data set will work with an artificial intelligence autoencoder at block 354 and deep learning neural network at block 356. Moreover, normalizing the data set allows the performance calculation model 310 to evaluate a wide range of quantitative and qualitative performance metrics.

Turning to block 354, an autoencoder may be used to remove outliers from the data set. The autoencoder is an artificial neural network that is trained to detect and exclude outliers from the data set, which ensures a more accurate baseline for performance calculations by identifying and removing anomalous patterns. The autoencoder may be a form of an unsupervised neural network. That is, the autoencoder functions even if the first data set is unlabeled. The autoencoder cleans the data so that the neural network will not be impacted by outliers and/or biases in the data set. For example, if a performance metric is mean time using the software feature, the autoencoder may determine that one data entry recording use of the software feature for 24 hours straight is an outlier (e.g., because the user forgot to close the software feature). As discussed in more detail at block 356, the first data set is used as training data to develop a performance calculation model. Because outlier data points may bias the performance calculation mode, the autoencoder is used to remove these points from the first data set.

Moving to block 356, the computing system trains a neural network with the first data set. The neural network takes one or more recognized positive performance characteristics, learns and identifies multi-dimensional patterns between the performance metrics in the data set, providing a more nuanced and adaptive understanding of productivity drivers. The neural network provides functionality because the relationship between positive performance characteristics and many performance metrics is often complex. By way of example, the disclosed performance system can be used to evaluate a software feature intended to benefit doctors treating patients. A radiologist may analyze X-Rays on a user interface with a new software feature, for example, an artificial intelligence image recognition functionality targeted at improving diagnosis efficiency. A positive performance characteristic may be returning a diagnosis to the patient in a threshold amount of time (e.g., less than 15 minutes). In this example, it would be nearly impossible to tell whether the new software feature actually benefitted the radiologist's performance because of a variety of other factors (i.e., performance metrics) that could impact the radiologist's ability to return a diagnosis within the time threshold. A few performance metrics that might be of interest in this example are the radiologists experience, the time of day the radiologist received the X-Ray, the queue of other images the radiologist needed to diagnose first, the complexity of the instant X-Ray, whether or not the radiologist actually used the software feature, whether the software feature and the radiologist reached the same conclusion, and many others. Individually these performance metrics all provide some indication of how the software feature impacted the radiologist's performance. However, a comprehensive view of the software feature would benefit from considering all these performance metrics over a period of time. Because these metrics are not guaranteed to fit into linear relationships, the neural network can be used to provide a more accurate determination of how these performance metrics interact.

Staying at block 356, the computing system may develop the performance calculation model 310 by training a neural network with the first data set according to some or all of the following steps, performed in any particular order. The computing system may select the most relevant performance metrics for inclusion into the performance calculation model 310 based on the performance metrics' shared information with the target metric (i.e., a positive performance characteristic). Here, the computing system calculates the dependency between performance metrics to identify which performance metrics will be most relevant for inclusion in the performance calculation model 310. Looking to the previous example, if the time of day that a radiologist received an X-Ray had little or no connection to the diagnosis time, that performance metric may be excluded from the performance calculation model 310. Next, the computing system may be configured to perform principal component analysis (PCA) to reduce dimensionality in the first data set. PCA may be useful for preserving the most relevant features in the first data set while reducing the size of the data set so that the neural network may run efficiently (i.e., time efficient and computationally resource efficient). In some embodiments, the first two steps of developing the performance calculation model may be unsupervised. That is, a neural network can be used to determine the most relevant performance metrics and perform PCA on those performance metrics even if they originate from an unlabeled data set. After performing PCA, the computing system may use a multi-layer perceptron (MLP) regressor or similar neural networks to dynamically model and weight the relationships between performance metrics. This approach allows the model to adapt to changing patterns in user behavior and provide more predictive insights over time. The MLP regressor is a feed forward neural network that processes data across multiple layers of nodes. Each node in a first layer is connected to every node in the following layer with each connection having an associated weight. The neural network updates the weights between connections based on error output and back propagation. The MLP regressor model, in this embodiment, is a supervised neural network. However, the MLP regressor is just one possible neural network model for generating the performance calculation model 310. In other embodiments, other neural network algorithms can be used to train the performance calculation model 310. Looking at block 356 from a broader view, the computing system generates the performance calculation model 310 through multiple neural network functions that may be supervised or unsupervised.

After the computing system trains the performance calculation model 310, the process continues at block 358. The computing system receives a second data set. The second data set includes data pertaining to at least some of the performance metrics found in the first data set. The second data set may be scaled and categorized according to the same process used on the first data set. The computing system uses the performance calculation model 310 developed at block 356 to calculate a performance score for the second data set. Applying the performance calculation model 310 to the second data set may return an unscaled performance score.

As described above, the neural network may generate the performance calculation model 310 by assigning weights and defining relationships between the relevant performance metrics. In some embodiments, the user may alter the performance calculation model 310. For example, the user may alter the weight provided to a subset of the performance metrics. Therefore, if the user values one or more performance metrics, it may provide greater weight to those performance metrics. The user may adjust the weights of performance metrics before or after the computing system generates the performance calculation model 310. Resultingly, the performance calculation model 310 may be based on the neural networks model's determination of relationships between performance metrics and supplemental user-provided information.

At block 360, the productivity score for the second data set may be scaled according to a predefined performance index. This ensures that performance scores are presented in an easily interpretable format and can be consistently compared across different users or use cases. The performance index is a range, for example, from 0.00-1.00, 0-100, 1-10, A-F, etc. In some embodiments, performance scores for a variety of users are scaled according to the performance index. Scaling the performance scores provides multiple benefits. First, it transforms performance scores into an easily comprehendible value, such that users can evaluate their own performances. Second, it may allow users to compare their productivity scores to other users using the same software feature. In this way, the scaled productivity score provides users with one comprehensive identifier of how the software feature has impacted their performance.

It should be noted that the second data set can refer to different users in various embodiments. For example, the second data set could refer to all users interacting within a software feature in a particular enterprise. Looking back to the use case provided at block 356, for example, the second data set could represent all doctors using the software feature across a chain of hospitals. In other embodiments, the second data set may represent performance metrics for a team or subset within an enterprise (e.g., all doctors at a particular hospital or all radiologists across all hospitals). Further, in other embodiments, the second data set may refer to one particular user. In this way, the performance score is highly scalable and may be useful for evaluating a software feature's performance across a variety of use cases.

Alternatively, the first and second data sets may refer to the same user. In some embodiments, the performance calculation model 310 may be configured to evaluate the performance of a new or updated software feature within an entity (e.g., a business, an enterprise, an organization, etc.). In these embodiments, the first data may include data about performance metrics before a software feature update and the second data set includes data about the same performance metrics after the software feature update. This embodiment allows the entity to perform an internal evaluation of how the software feature has impacted its performance.

In some embodiments, at block 360, the computing system may apply an autoencoder to the second data set. Applying an autoencoder further refines the scaled performance score for the second data set so the score is a more accurate indicator of performance. As described above, the autoencoder may be an unsupervised artificial neural network that can remove anomalies from the second data set. In some embodiments, the performance score for the second data set may be updated over time. For example, the second data set may expand over time as more data becomes available. The computing system may be configured to routinely calculate performance scores for the second data set so that it is dynamically changing as more data becomes available. Because the performance score may be updated over time, users may be able to track how their performance improves or declines as they become more familiar with the software feature.

Further, in other embodiments, the neural network of block 356 may also be trained using the data of the second data set. That is, data associated with the second data set may inform the productivity score that is ultimately assigned to the second data set. For example, historical data about the user providing the second data set may be considered to adjust the second data set's productivity score. This is referred to as scaling the productivity score according to the adoption factor of the second data set. Indeed, certain users adjust to software features faster than others. For example, on balance, software developers historically use and become more efficient with software features faster than less technologically experienced user groups. The adoption factor is used to reflect the learning ability of the user associated with the second data set. Because a user with a low adoption factor may initially have an unduly low performance score for the software feature, the neural network may use the adoption factor as a performance metric to account for the user's learning period with the software feature.

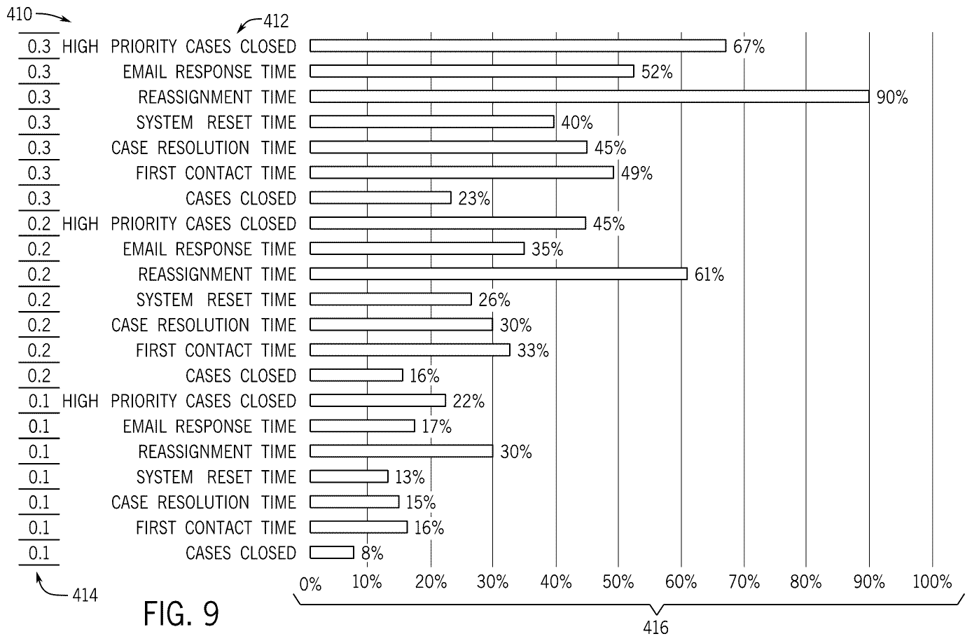

Continuing to block 362, because the neural network has generated a performance calculation model 310 for the metrics with the most productivity, the computing system may identify the performance metrics with the greatest impact on performance. Thus, the computing system is configurable to provide user feedback for increasing their performance score. For example, the computing system may provide users with different options for increasing their performance score by different amounts. Thus, users may be able to determine the performance metrics that are most critical to increasing their overall performance when using the software feature. This will be discussed in more detail with regard to FIG. 9 below.

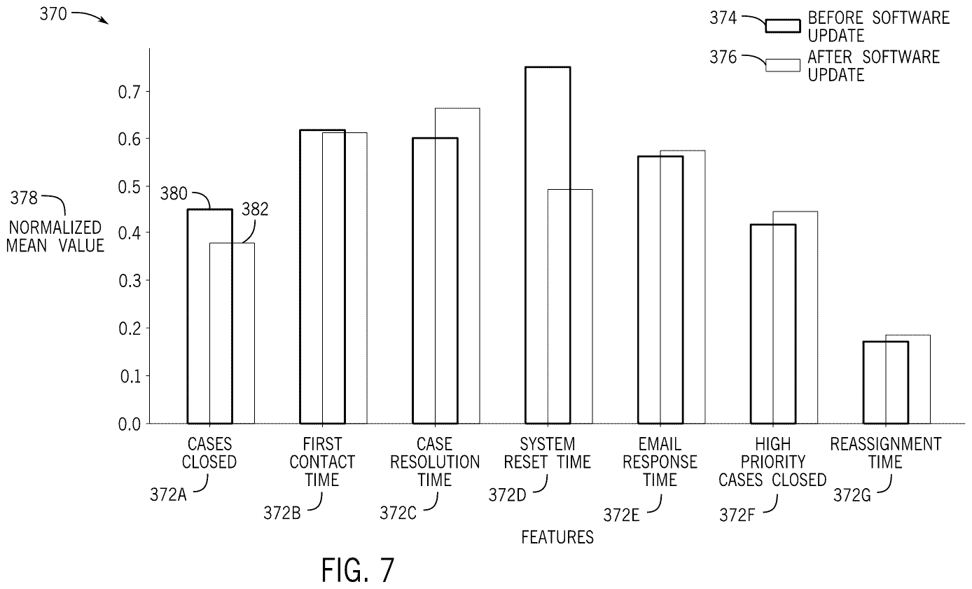

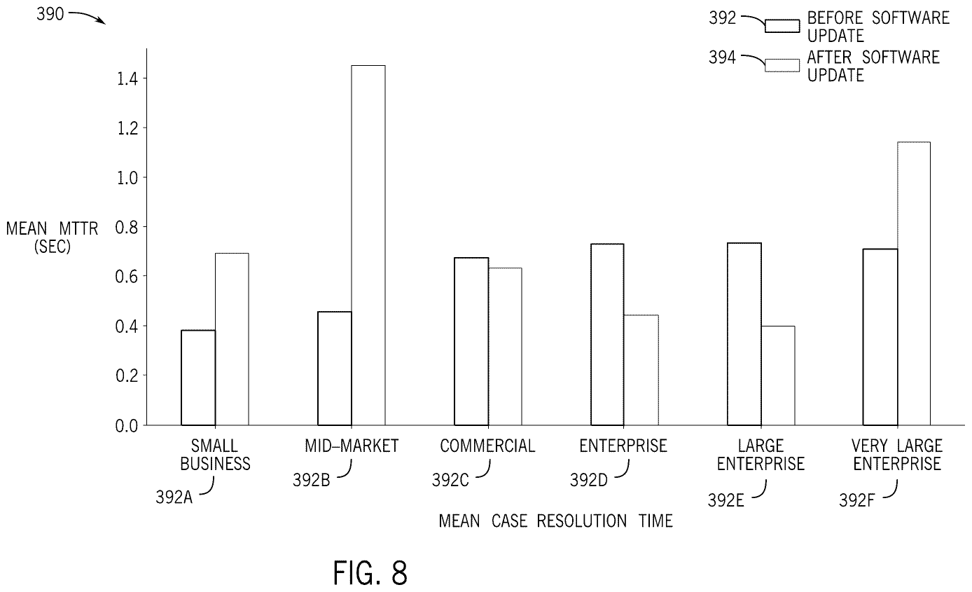

Turning now to a practical implementation of the performance calculation model 310, FIGS. 7 and 8 provide examples of performance metric data that the computing system receives to construct the performance calculation model 310. FIG. 7 shows a graph 370 of productivity metrics 372A-G on a software platform before 374 and after 376 a software feature was added to the platform. In this example, the performance metrics 372A-G relate to productivity of IT staff in an enterprise system. The performance metrics depicted in this example include, mean number of cases closed 372A, mean first contact time 372B, mean case resolution time 372C, mean time of performing a system reset 372D, mean email response time 372E, total number of high priority cases closed 372F, and mean time to reassign the case to a more specialized team 372G. These metrics all relate to overall productivity on the software platform. By comparing the performance metrics 372A-G before and after the addition of the software feature, the user using the software feature can identify whether the software feature increased the performance and productivity of its IT staff. The performance metrics 372A-G have a normalized value for the first data set of performance metric data before the software feature 380 and performance metric data after the software feature 382.

FIG. 8 provides a graphical representation 390 of how the performance calculation model 310 may be tailored to the user associated with the second data set. Continuing with the example from FIG. 7, the graph 390 displays mean case resolution time 372C for enterprise IT staff across a variety of organization sizes 392A-F. The organization sizes range from small business 392A to very large enterprise 392F. Identifying the sources of performance metric data may be useful for the neural network to tailor the performance score to the user providing the second data set. Similarly, the source of the performance metric data may impact the adoption factor (i.e., scaling the performance score to be specific to the organization).

FIG. 9 provides a graph 410 of possible suggestions for the user providing the second data set to improve its performance score. The model offers targeted recommendations on which performance metrics should be adjusted to achieve productivity improvements. For example, the same performance metrics 412 depicted in FIG. 7 are listed on the vertical axis. Next to the performance metrics is a range of performance improvements 414. The performance improvements 414 provide an estimated amount by which the performance score can be improved. For example, in this graph 410, the performance improvements 414 range from 0.1 at the bottom of the graph to 0.3 at the top of the graph. The horizontal axis 416 refers to the corresponding percent improvement to achieve for the respective performance metric 412 to obtain the associated performance improvement. As illustrated in the top row of the graph, for example, improving the total number of high priority cases closed by 67 percent could lead to a corresponding increase in the performance score by 0.3. These suggestions allow users to determine how they can become more productive using the software feature. Likewise, the suggestions provide users with an indication of what performance metrics have the greatest effect on positive performance. For example, according to the graph 410, improving the total number of cases closed by 23% has the same impact on performance as improving email response time by 52%; this suggestion indicates that closing cases is more important to IT performance than having quick initial responses.

The disclosed techniques include evaluating performance shifts in response to the release of software features. A computing system is configured to evaluate software feature performance by synthesizing multiple performance metrics into a performance score. The performance score may then be scaled according to a predefined performance index ranging from 0.00-1.00, 0-100, or other suitable ranges with the desired granularity (e.g., 0-10, 0-1,000, and so forth). The performance index range may be used to scale performance scores for each user, group of users, or enterprise (collectively referred to as “users”) using the software feature. The scaled performance score provides users with a holistic measure of how the software feature has impacted their performance. To calculate a user-specific performance score, the computing system generates a performance calculation model through a two-phase process. The first phase of generating the performance calculation model is directed to obtaining usable data to train a neural network. In some embodiments, the computing system receives data entries from multiple users using a software feature. Each data entry may be associated with one or more performance metrics (e.g., mean time spent using the software feature). The computing system scales the data for use in machine learning algorithms and an autoencoder removes outliers from the training data.

After the training data is cleaned and identified, the second phase of generating the performance calculation model is training the neural network using the training data. Because relationships between performance metrics may be non-linear, the neural network is used to capture patterns in the training data, weigh performance metrics, and generate the performance calculation model. The performance calculation model represents a performance formula for all users, represented in the data entries, that use the software feature. Once the computing system generates the performance calculation model, it may use the model to calculate the performance scores for other users interacting with the software feature. Alternatively, the performance calculation model may be useful for one user to compare its own performance after implementing the software feature. After calculating the performance score, the computing system may scale the score according to the predefined performance index.

In some embodiments, the neural network may be configured to provide users with feedback for increasing productivity. For example, if a user seeks to increase its performance score by a set amount (e.g., 0.05), the computing system may use the neural network to identify and display instructions regarding one or more performance metrics that can be improved to reach the user's desired performance score. Further, in some embodiments, the neural network is configured to account for a user's propensity to adapt to updates to software features (the “adoption factor”). By incorporating early usage data, initial performance trends, and feedback patterns to adjust productivity scores accordingly, the adoption factor provides each user with a more accurate performance evaluation by using machine learning to determine the user's time to learn the software feature and scaling the user's performance score to account for decreases in productivity during learning periods. Accordingly, the disclosed systems and methods for evaluating performance shifts associated with software features provide a more holistic and tailored approach to doing so.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. A method, comprising:
providing, to a trained neural network, a data set including a first plurality of data entries, wherein the data set is associated with a usage of a software feature, wherein the trained neural network is configured to identify relationships between a plurality of performance metrics respectively characterizing the first plurality of data entries, wherein the trained neural network includes a performance calculation model associated with the software feature;
applying the performance calculation model to the data set to generate a performance score; and
transmitting the performance score to a device associated with the data set for display.

2. The method of claim 1, comprising:
scaling the performance score according to a performance index, wherein the performance index is a predefined numerical range.

3. The method of claim 2, wherein the data set originates from an entity.

4. The method of claim 3, scaling of the performance score is based on historical data associated with the entity.

5. The method of claim 1, wherein the neural network is configured to assign respective weights to the plurality of performance metrics.

6. The method of claim 5, wherein a first performance metric of the plurality of performance metrics has a larger weight than a second performance metric of the plurality of performance metrics.

7. The method of claim 5, comprising:
modifying the respective weights assigned to a first performance metric of the plurality of performance metrics based on a received input.

8. A system comprising:
processing circuitry; and
a memory accessible by the processing circuity, and storing instructions that, when executed by the processing circuitry, cause the processing circuitry to execute a client instance, wherein the client instance is configured to perform operations comprising:
providing, to a trained neural network, a data set including a first plurality of data entries, wherein the data set is associated with a usage of a software feature, wherein the trained neural network is configured to identify relationships between a plurality of performance metrics respectively characterizing the first plurality of data entries, wherein the trained neural network includes a performance calculation model associated with the software feature;
applying the performance calculation model to the data set to generate a performance score; and
transmitting the performance score to a device associated with the data set for display.

9. The system of claim 8, wherein the operations comprise:
identifying, based on user interaction data, user productivity data, external metric data, user historical data, or any combination thereof, the one or more performance metrics that impact the performance score.

10. The system of claim 8, wherein the operations comprise:
applying an autoencoder to identify and remove outlier data points from the data set.

11. The system of claim 8, wherein the operations comprise:
scaling the performance score according to a performance index, wherein the performance index is a predefined numerical range.

12. The system of claim 11, wherein the data set originates from an entity.

13. The system of claim 12, wherein the performance score is indicative a productivity measure of the entity using the software feature.

14. The system of claim 13, wherein the operations comprise:
scaling the performance score based on historical data associated with the entity.

15. A non-transitory, computer readable medium comprising instructions that, when executed by processing circuitry, cause the processing circuitry to perform operations comprising:
providing, to a trained neural network, a data set including a first plurality of data entries, wherein the data set is associated with a usage of a software feature, wherein the trained neural network is configured to identify relationships between a plurality of performance metrics respectively characterizing the first plurality of data entries, wherein the trained neural network includes a performance calculation model associated with the software feature;
applying the performance calculation model to the data set to generate a performance score; and
transmitting the performance score to a device associated with the data set for display.

16. The non-transitory computer readable medium of claim 15, wherein the operations comprise:
scaling the performance score according to a performance index, wherein the performance index is a predefined numerical range.

17. The non-transitory computer readable medium of claim 15 wherein the data set originates from an entity.

18. The non-transitory computer readable medium of claim 15, wherein the operations comprise:
identifying, based on user interaction data, user productivity data, external metric data, user historical data, or any combination thereof, a first performance metric of the plurality of performance metrics that impacts the performance score.

19. The non-transitory computer readable medium of claim 18, wherein the operations comprise:
generating feedback for the entity associated with the data set to improve the performance score.

20. The non-transitory computer readable medium of claim 19, wherein the feedback to increase the performance score indicates a suggested improvement to the first performance metric.
